(19) United States
(12) Patent Application Publication
(10) Pub. No.: US 2007/0259093 A1
(43) Pub. Date: Nov. 8, 2007

(54) Process for thickening food having reduced oil and fat content

(76) Inventor: Peter J. Williamson, Gloucester, MA (US)

Correspondence Address: Paul J. Cook, 115 Pine Street, Manchester, MA, 01944, US

(21) Appl. No.: 11/417,462

(22) Filed: May 5, 2006

(51) Int. Cl. A23L 1/40

(52) U.S. Cl. 426/589

(57) ABSTRACT

A homogeneous cooked roux is formed by heating a mixture of (a) a starchy food and (b) a dry protein mixture, an aqueous alkaline protein mixture or an aqueous acidic protein. The dry protein mixture, aqueous alkaline protein mixture and aqueous acidic protein solution comprise myofibrillar proteins and sarcoplasmic protein derived from animal muscle tissue and are substantially free of myofibrils and sarcomeres.

### BACKGROUND OF THE INVENTION

This invention relates to a process for thickening food having a reduced oil and fat content and to the roux product obtained by this process. More particularly, this invention relates to such a process which utilizes animal muscle protein or a peptide composition derived from animal muscle protein to thicken food having a reduced oil and fat and to the roux product obtained by the process.

Prior to the present invention, a base for sauces, soups, gravies and the like, known as “roux” is made and which functions as a thickening agent for the food to be finally produced. Presently, the roux comprises a mixture of a (1) a food having a high starch concentration (starchy food) such as flour, corn starch, potato, arrowroot and the like and (2) a fatty composition such as drippings from cooked meat or fish, butter, bacon fat, mixtures thereof and the like. This mixture is then heated to remove the raw pasty taste of the starchy food and to form a homogeneous thick mixture. The roux then is combined with a liquid food such as a soup, gravy base, sauce base or the like. The resultant food is thicker than the liquid food without the roux. Unfortunately, this process of forming the roux contains a larger concentration of fat which in many instances is unhealthful to the consumer of the food.

Accordingly, it would be desirable to provide a roux and a method of forming the roux which has a fat content at least about 50% less fat than presently available roux. In addition, it would be desirable to provide such a form of roux which is not less nutritional than the presently available roux or which is even more nutritional than the presently available roux.

### SUMMARY OF THE INVENTION

In accordance with this invention, a roux is provided comprising a cooked homogeneous mixture of a starchy food and a protein mixture derived from animal muscle tissue and/or with a peptide composition derived from the protein mixture which may or may not contain added water. The protein mixture can be a dry protein mixture, an aqueous acidic protein solution, derived from animal muscle tissue, an aqueous alkaline protein solution derived from animal muscle tissue and/or a peptide composition derived from the aqueous acidic protein solution or from the aqueous alkaline protein solution or from the dry protein mixture. The protein solutions or mixtures comprise a mixture of myofibrillar proteins and sarcoplasmic proteins obtained by one of the processes disclosed in U.S. Pat. Nos. 6,005,073; 6,288,216; 6,136,959 and/or 6,451,975 all of which are incorporated herein by reference in their entirety. By the phrase, “dry protein mixture” as used herein is meant a dehydrated, protein mixture of myofibrillar proteins and sarcoplasmic proteins derived from animal muscle tissue and which is obtained from the aqueous acidic protein solution (less than or equal to pH 4.0) (acidic dry protein mixture) or the aqueous alkaline protein solution (greater than or equal to pH 10.5) (alkaline dry protein mixture). The dry protein mixture also contains less than about 15 weight percent water, preferably between about 3 and 10 weight percent water and most preferably between about 3 and 7 weight percent water based on the total weight of the protein mixture and water. While a dry protein mixture containing 0% water is useful in the present invention, dry powders, in general, containing 0 to 3 weight percent water can be dangerous to process on a commercial scale. Solid mixtures of myofibrillar proteins and sarcoplasmic proteins containing greater than about 15 weight percent water based on total weight of the protein mixture and water are undesirable in this invention since they are microbially unsound.

By the phrase “aqueous acidic protein solution” as used herein is meant an aqueous solution of myofibrillar proteins and sarcoplasmic proteins derived from animal muscle tissue and having a pH of 4.0 or less, preferably pH 3.5 or less and most preferably between about 2.5 and about 3.5 but not so low as to adversely affect the protein functionality. The aqueous acidic protein solution can be obtained directly from animal muscle tissue by the processes described below or by dissolving the dry protein mixture in water or in a pharmaceutically or food grade acceptable aqueous acidic solution.

By the phrase, “aqueous alkaline protein solution” as used herein is meant an aqueous solution of myofibrillar proteins and sarcoplasmic proteins having a pH from about 10.5 to about 12.0. The aqueous alkaline protein solution can be obtained directly from animal muscle tissue by the processes described below. A dry alkaline protein mixture useful in the present invention is obtained by drying the aqueous alkaline protein solution such as by lyophilization, evaporation or spray drying.

In accordance with this invention a starchy particulate or ground food is mixed with the dry protein mixture, aqueous acidic protein solution, aqueous alkaline protein solution and/or a peptide composition derived therefrom of this invention. The mixture is then cooked to form a homogenous mixture comprising the roux. The roux also can contain milk, cream, and or a fat in order to obtain roux having improved homogeneity. The roux of this invention contains at least about 50% less fat than presently available roux which does not utilize the protein compositions derived from animal muscle tissue and/or peptide derived therefrom of this invention.

### DESCRIPTION OF SPECIFIC EMBODIMENTS

In accordance with this invention a roux comprising a mixture of a (1) particulate or ground a food having a high starch concentration (starchy food) such as flour, corn starch, potato, arrowroot and the like and (2) a mixture of myofibrillar protein and sarcoplasmic protein derived from animal muscle tissue is formed by mixing (1) and (2). This mixture of myofibrillar proteins and sarcoplasmic protein derived from animal muscle tissue can be a dry protein mixture or an aqueous acidic protein solution or an aqueous alkaline protein solution and/or a peptide composition derived from the dry protein mixture, the aqueous acidic protein solution or the aqueous alkaline protein solution. The dry protein mixture, aqueous alkaline protein solution and aqueous acidic protein solution are obtained by the processes disclosed in U.S. Pat. Nos. 6,005,073, 6,288,216, 6,136,959 and 6,451,975 all of which are incorporated herein by reference in their entirety. The peptide composition utilized in the present invention is obtained by contacting the dry protein mixture, the aqueous acidic protein solution, or the aqueous alkaline protein solution with an enzyme that converts the protein to a peptide. This dry protein mixture is obtained by one of four processes. In two processes, (acid processes) animal muscle tissue is formed into small tissue-particles which are then mixed with sufficient acid to form a solution of the tissue having a pH of 4.0 or less, preferably 3.5 or less and most preferably between about 2.5 and about 3.5, but not such a low pH as to adversely modify the animal tissue protein. In one of these two processes, the solution is centrifuged to form a lowest membrane lipid layer, an intermediate layer of aqueous acidic protein solution and a top layer of neutral lipids (fats and oils). The intermediate layer of aqueous acidic protein solution then is separated from the membrane lipid layer or from both the membrane lipid layer and the neutral lipid layer. In a second of these two processes, no centrifugation step is effected since the starting animal muscle tissue contains low concentrations of undesired membrane lipids, oils and/or fats. In both processes, the protein mixture is free of myofibrils and sarcomeres. In both processes, the protein in the aqueous acidic protein solution is recovered after centrifugation (when used) or by drying the aqueous acidic solution, such as by evaporation, spray drying or lyophilization to form the dry protein mixture having the low pH it had when it was dissolved in the aqueous acidic protein solution. Alternatively, the aqueous acidic protein solution can be utilized with the starchy food without drying the solution. It is preferred to utilize one of these two acid processes to obtain the dry protein mixture or the aqueous acidic protein solution. In another alternative process, the protein in the aqueous acidic protein solution can be precipitated and recovered and mixed with a pharmaceutically acceptable or food grade acid to form an aqueous acidic protein solution of a desired viscosity. In another alternative process, the proteins in the acidic protein solution can be raised to a pH between about 10.5 and 12 using base to form an aqueous alkaline protein solution.

In two other processes, (alkaline processes) which also provide a means for obtaining an alkaline dry protein mixture, animal muscle tissue is formed into small tissue particles which are then mixed with sufficient aqueous base solution to form a solution of the tissue wherein at least 75% of the animal muscle protein is solubilized, but not such a high pH as to adversely modify the animal tissue protein, i.e., a pH between about 10.5 and about 12. In one process, the solution is centrifuged to form a lowest membrane lipid layer, an intermediate aqueous protein rich layer and a top layer of neutral lipids (fats and oils). The intermediate aqueous alkaline protein-rich layer then is separated from the membrane lipid layer or from both the membrane lipid layer and the neutral lipid layer. In a second process, no centrifugation step is effected since the starting animal muscle proteins contain low concentrations of undesired membrane lipids, oils and/or fats. In both processes, the protein mixture is free of myofibrils and sarcomeres. In both of these processes, the aqueous alkaline protein solution can be recovered at this point. In both processes, the pH of the protein-rich aqueous phase can be lowered to a pH below about 4.0, preferably below about 3.5 and most preferably between about 2.0 and 3.5 to form the aqueous acidic protein solution. In both processes, the protein in the aqueous acidic protein solution is recovered after centrifugation (when used) by drying the aqueous acidic protein solution, such as by evaporation, spray drying or lyophilization to form a powder product having the low pH it had when it was dissolved in the aqueous acidic solution. Alternatively, the aqueous acidic protein solution can be mixed with the starchy food without drying. The protein in aqueous alkaline solution having a pH between about 10.5 and 12.0 recovered after centrifugation (when used) can be dried, such as by spray drying, evaporation or lyophilization to form a powder product.

The dry protein mixture, the aqueous acidic protein solution or the aqueous alkaline protein solution then is mixed with the particulate or ground starchy food. The resultant mixture then is cooked usually with stirring to form a homogeneous roux free of raw pasty taste of the uncooked starchy food. Representative suitable particulate or ground starchy foods suitable for forming the roux of this invention include flour, corn starch, potato, arrowroot, or mixtures thereof and the like. The roux of this invention also can contain small amounts of a normal additive for a roux such as milk, cream or fat in order to obtain a roux of desired thickness. In any event, the roux of this invention made with the protein composition described herein have less than about 50 wt. % fat, preferably less than about 40% fat and most preferably less than about 20 wt. % fat than presently available roux. The roux also can contain flavorants such a butter flavor or garlic flavor or the like.

In summary, the dry protein mixture, aqueous alkaline protein mixture or the aqueous acidic protein solution utilized in the present invention can be obtained by the following representative methods:

1. Reduce the pH of comminuted animal muscle tissue to a pH less than about 3.5 to form an acidic protein solution, centrifuge the solution to form a lipid-rich phase and an aqueous phase and recover an aqueous acidic protein solution substantially free of membrane lipids that can be used in this invention.

2. Spray dry the aqueous acidic protein solution obtained by method 1 to form a dry protein mixture substantially free of membrane lipids that can be used in the present invention.

3. Lyophilize or evaporate the aqueous acidic protein solution obtained by method 1 to form the acidic dry protein mixture substantially free of membrane lipids that can be used in the present invention.

4. Increase the pH of the aqueous acidic protein solution from method 1 to about pH 5.0-5.5 to effect precipitation of the proteins and then readjust the protein back to a pH of about 4.5 or less using acid in a minimum volume to concentrate the aqueous acidic protein solution to between 1.6-15% protein.

5. Reduce the pH of comminuted animal muscle tissue to form an aqueous acidic protein solution that can be used in the present invention.

6. Spray dry the aqueous acidic protein solution obtained by method 5 to form the acidic dry protein mixture that can be used in the present invention.

7. Lyophilize or evaporate the aqueous acidic protein solution obtained by method 5 to form the acidic dry protein mixture that can be used in the present invention.

8. Increase the pH of the aqueous acidic protein solution from method 5 to about pH 5.0-5.5 to effect precipitation of the proteins and then readjust the protein back to a pH of about 4.0 or less using acid in a minimum volume to concentrate the aqueous acidic protein solution to between about 1.6-15% protein.

9. Increase the pH of comminuted animal muscle tissue to a pH above about 10.5, centrifuge the solution to form a lipid-rich phase and an aqueous phase and recover an aqueous alkaline protein solution. In one embodiment, reduce the pH of the aqueous alkaline solution to a pH of less than about 4.0 to obtain an aqueous acidic protein solution substantially free of membrane lipids that can be used in this invention. In a second embodiment, reduce the pH of the aqueous alkaline solution to about 5.0-5.5 to precipitate the protein, lower the pH of the precipitated protein to a pH of 4.0 or less to form a concentrated aqueous acidic protein solution and use the concentrated aqueous acidic solution or dry the solution and use the recovered dry protein.

10. Spray dry the aqueous acidic protein solution obtained by method 9 to form a dry protein mixture substantially free of membrane lipids that can be used in the present invention.

11. Lyophilize or evaporate the aqueous acidic protein solution obtained by method 9 to form the acidic dry protein mixture substantially free of membrane lipids that can be used in the present invention.

12. Increase the pH of the aqueous acidic protein solution from method 9 to about pH 5.0-5.5 to effect precipitation of the proteins and then readjust the protein back to a pH of about 4.0 or less using acid in a minimum volume to concentrate the aqueous acidic solution to between 1.6-15% protein.

13. Increase the pH of comminuted animal muscle tissue to a pH above about 10.5 to form the aqueous alkaline protein solution. In one embodiment, reduce the pH of the aqueous alkaline protein solution to below about 4.0 to form an aqueous acidic protein solution that can be used in the present invention. In a second embodiment, reduce the pH of the aqueous alkaline solution to about 5.0-5.5 to precipitate the protein, lower the pH of the precipitated protein to a pH of 4.0 or less to form a concentrated aqueous acidic solution and use the concentrated aqueous acidic protein solution or dry the solution and use the recovered dry protein mixture.

14. Spray dry the aqueous acidic protein solution obtained by method 13 to form an acidic dry protein mixture that can be used in the present invention.

15. Lyophilize or evaporate the aqueous acidic protein solution obtained by method 13 to form the acidic dry protein mixture that can be used in the present invention

The protein products utilized in the present invention comprise primarily myofibrillar proteins that also contains significant amounts of sarcoplasmic proteins. The sarcoplasmic proteins in the protein product comprise above about 8%, preferably above about 10%, more preferably above about 15% and most preferably above about 18%, up to about 30% by weight sarcoplasmic proteins, based on the total weight of protein in the dry protein mixture, the aqueous alkaline protein solution and/or aqueous acidic protein solution.

The protein solution or protein mixture is derived from the animal muscle tissue of meat, poultry or fish, including shellfish muscle tissue. Representative suitable fish include deboned flounder, sole haddock, cod, sea bass, salmon, tuna, trout or the like. Representative suitable shellfish include shelled shrimp, crayfish, lobster, scallops, oysters or shrimp in the shell or like. Representative suitable meats include beef, lamb, pork, venison, veal, buffalo or the like; poultry such as chicken, mechanically deboned poultry meat, turkey, duck, a game bird or goose or the like.

In accordance with one embodiment of this invention, the dry protein mixture, aqueous alkaline protein solution or aqueous acidic protein solution of myofibrillar proteins and sarcoplasmic protein is mixed with one or more enzymes, which convert the protein to peptides thereby to produce a peptide composition which is added to starchy food prior to cooking the starchy food to produce the roux. The enzymes can be exoproteases and can be active to produce peptides at an acidic pH, an alkaline pH or a neutral pH. Representative suitable enzymes useful at acidic pH include Enzeco Fungal Acid Protease (Enzyme Development Corp., New York, N.Y.; Newlase A (Amano, Troy, Va.); and Milezyme 3.5 (Miles Laboratories, Elkhart, Ind.) or mixtures thereof. Representative suitable enzymes useful at alkaline pH include Alcalase 2.4 LFG (Novozyes, Denmark). Representative suitable enzymes useful at neutral pH include Neutrase 0.8 L (Novozymes, Denmark) and papain (Penta, Livingston, N.J.) or mixtures thereof. After, the peptides have been formed, their pH can be adjusted, either alone or in admixture with the protein composition of this invention to pH below about 4.0 or between about 10.5 and about 12.0 prior to cooking them to with the starchy food to form a roux.

The enzymes utilized in amounts of between about 0.02% and about 2% preferably between about 0.05% and about 0.5% by weight based on the total weight of enzyme and protein at temperatures between about 4° C. and about 55° C., preferably between about 25° C. and about 40° C., for a time between about 5 mins. and about 24 hrs., preferably between about 0.5 hrs. and about 2 hrs. The enzyme can be inactivated by changing pH of the protein composition with which it is mixed. The peptides formed by reaction of the protein composition with the enzyme composition then can be recovered by drying the solution wherein the reaction takes place. Drying can be effected by evaporation, spray drying, freeze-drying or the like. The peptides produced are instantaneously soluble in water at neutral pH. The peptide composition can be added to uncooked food for the purposes set forth above.

The peptide products useful in this invention contain less than about 1 weight percent fats and oils (total), preferably less than about 0.2% weight percent fats and oils based on the weight of peptide. In addition, the peptide products utilized in the present invention contain less than about 2 weight percent ash, preferably less than about 0.2% weight percent fats and oils based on the weight of peptide. This low ash content is achieved by washing with water the protein starting material. Ash is defined as minerals, such as sodium, potassium, calcium, iron or phosphorous. In addition, the peptide products of this invention are instantly soluble in water to form a clear solution. Furthermore, the peptide products of this invention generally have lighter color whiteness units than the color whiteness units of a similar unhydrolyzed protein isolate from which they are derived as measured by a calorimeter with L, a, b capabilities. This lighter color is found with the hydrolyzed peptides of this invention derived from meats such as beef, pork or chicken as well as from dark muscle tissue from fish such as pelagic fish. This lighter color characteristic is desirable since it more easily permits dissolving the peptide product in water to form clear aqueous solutions.

Color whiteness index is determined by converting the L, a, b values utilizing the formula: 100 [(100−L)²+a²+b²]^{0.5} Color is measured using a tristimulus colorimeter utilizing the universally adopted “L, a, b” opponent-type scale developed by Richard Hunter as is well known in the art. “L” is a measure of light ranging from white to black. The “a” value measures the range from green to red, and the “b” value measures the range from blue to yellow. With these three coordinates, a three-dimensional value can be assigned to any color.

In accordance with this invention, the dry protein mixture, aqueous alkaline protein solution or aqueous acidic protein solution comprising myofibrillar proteins and sarcoplasmic proteins and/or the peptide composition derived therefrom is mixed with the starchy food at a weight ratio of starchy food to protein of about 1:0.5 to about 1:2.0, preferably about 1:0.8 to about 1:1.2.

The starchy food containing the dry protein mixture, aqueous alkaline protein solution or aqueous acidic protein solution and/or the peptide composition then can be cooked in a conventional manner such as by pan frying, or the like.

The following example illustrates the present invention and are not intended to limit the same. All products were analyzed at Silliker Laboratory, Allentown, Pa. Analysis method was fat (AOAC 933.05).

### EXAMPLE 1 EXTRACTED CLAM MUSCLE TISSUE PROTEIN TO FORM A ROUX WITH REDUCED FAT

The process of this example provides a clam muscle based roux suitable for making clam chowder.

A clam muscle tissue protein solution was manufactured according to U.S. Pat. No. 6,451,975.

Fresh clam muscle tissue pieces free of clam stomach were ground (Stephan Micro-cut, Columbus, Ohio) and then acidified in phosphoric acid, pH 2.8-3.0 to form the clam protein solution having a Brix of 2.5-3.0 which corresponds to a 2.5-3.0 wt. % protein.

A control roux (control 1) was made from flour and butter at a weight ratio of flour to butter of 1:1 to which was added milk and light cream and which was cooked in a pan while stirring at about 300° F. for 6 minutes to form a homogenous cooked roux mixture. The roux then was mixes with milk, cream, precooked onion, spices, whole clams and uncooked potato cubes and cooked for 30 minutes to produce and edible chowder.

A first roux of this invention was formed by mixing the protein solution containing 3. 5 wt. % protein with flour and butter which contains 10 wt. % fat. The roux contains 10 part by weight butter, 40 parts by weight protein solution and 50 parts by weight flour. In contrast, a roux of the prior art is made with about 50 wt. % fat. The mixture was cooked in a pan while stirring at about 300° F. for six minutes until a homogeneous cooked roux was obtained. The roux then was cooked in a mixture of milk, cream, precooked onions, spices, whole clams and uncooked potato cubes for 30 minutes to produce an edible chowder which includes diary products.

A second roux of this invention was formed by mixing the protein solution containing 3.5 wt. % protein with flour at a weight ratio of flour to protein solution of 1:1. The mixture was cooked in a pan with stirring at about 300° F. for 6 minutes until a homogeneous cooked roux mixture was formed. The roux then was mixed with water, the clam protein solution, precooked onions, uncooked potato cubes, clams and spices and cooked at 300° F. for 30 minutes to produce an edible chowder that does not include dairy products.

Each roux was analyzed for fat content. These values where then compared to the fat content of a roux utilized in a commercially available clam chowder (Galilean Seafoods). (Control 2) and with Control 1.

A cup of chowder equals 245 grams. The roux samples and roux controls were tested for fat content (wt. %) by AOAC Method 933.05 with the results set forth in Table 1.

TABLE 1

| | | Fat Reduction | Fat Reduction |
|---|---|---|---|
| | Wt % Fat | Vs Control (1) | Vs Control (2) |
| Sample with | 1% | 98% | 98% |
| Roux, No fat | | | |
| Sample with | 11% | 78% | 78% |
| Roux, some fat | | | |
| Control 1 | 50% | | |
| Control 2 | 50% | | |

1. A roux composition comprising a cooked homogenous mixture of:
(a) a particulate or ground starchy food and
(b) a protein composition and/or a peptide composition selected from the group consisting of an acidic dry protein mixture of myofibrillar protein and sarcoplasmic proteins derived from animal muscle tissue, an aqueous acidic protein solution of myofibrillar proteins and sarcoplasmic proteins, a peptide composition derived from myofibrillar proteins and sarcoplasmic proteins that are derived from animal muscle tissue and mixtures thereof.

2. The composition of claim 1 wherein the starchy food is flour.

3. The composition of claim 1 wherein the starchy food is corn starch.

4. The composition of claim 1 wherein the starchy food is arrowroot.

5. A roux composition comprising a cooked homogenous mixture of:
(a) a particulate or ground starchy food and
(b) a protein composition and/or a peptide composition selected from the group consisting of an alkaline dry protein mixture of myofibrillar protein and sarcoplasmic proteins derived from animal muscle tissue, an aqueous alkaline protein solution of myofibrillar proteins and sarcoplasmic proteins, a peptide composition derived from myofibrillar proteins and sarcoplasmic proteins that are derived from animal muscle tissue and mixtures thereof.

6. The composition of claim 5 wherein the starchy food is flour.

7. The composition of claim 5 wherein the starchy food is corn starch.

8. The composition of claim 5 wherein the starchy food is arrowroot.

9. The process for forming a homogeneous roux composition which comprises mixing
(a) a particulate or ground starchy food and
(b) a protein composition and/or a peptide composition selected from the group consisting of an acidic dry protein mixture of myofibrillar protein and sarcoplasmic proteins derived from animal muscle tissue, an aqueous acidic protein solution of myofibrillar proteins and sarcoplasmic proteins, a peptide composition derived from myofibrillar proteins and sarcoplasmic proteins that are derived from animal muscle tissue and mixtures thereof,
and heating said mixture until a homogeneous cooked roux composition is formed.

10. The process of claim 9 wherein the starchy food is flour.

11. The process of claim 9 wherein the starchy food is corn starch.

12. The process of claim 9 wherein the starchy food is arrowroot.

13. A roux composition comprising a cooked homogenous mixture of:
(a) a particulate or ground starchy food and
(b) a protein composition and/or a peptide composition selected from the group consisting of an alkaline dry protein mixture of myofibrillar protein and sarcoplasmic proteins derived from animal muscle tissue, an aqueous alkaline protein solution of myofibrillar proteins and sarcoplasmic proteins, a peptide composition derived from myofibrillar proteins and sarcoplasmic proteins that are derived from animal muscle tissue and mixtures thereof.

14. The process of claim 13 wherein the starchy food is flour.

15. The process of claim 13 wherein the starchy food is corn starch.

16. The process of claim 13 wherein the starchy food is arrowroot.

17. The roux of any one of claims 1, 2, 3 or 4 wherein the animal muscle tissue is fish.

18. The roux of any one of claims 1, 2, 3 or 4 wherein the animal muscle tissue is poultry.

19. The roux of any one of claims 1, 2, 3 or 4 wherein the animal muscle tissue is meat.

20. The roux of claim 18 wherein the poultry is chicken.

21. The roux of any one of claims 5, 6, 7 or 8 wherein the animal muscle tissue is fish.

22. The roux of any one of claims 5, 6, 7 or 8 wherein the animal muscle tissue is poultry.

23. The roux of any one of claims 5, 6, 7 or 8 wherein the animal muscle tissue is meat.

24. The roux of claim 22 wherein the poultry is chicken.

25. The process of any one of claims 9, 10, 11 or 12 wherein the animal muscle tissue is fish.

26. The process of any one of claims 9, 10, 11 or 12 wherein the animal muscle tissue is poultry.

27. The process of any one of claims 9, 10, 11 or 12 wherein the animal muscle tissue is meat.

28. The process of claim 26 wherein the poultry is chicken.
